(19) United States
(12) Patent Application Publication
(10) Pub. No.: US 2016/0250667 A1
(43) Pub. Date: Sep. 1, 2016

(54) Finger Wipe Device

(71) Applicant: HERNÁNDEZ SEGURA Carmen, Barcelona (ES)

(72) Inventors: Carmen Hernandez Segura, Barcelona (ES); Jeronimo Gonzalez Gargallo, Barcelona (ES)

(21) Appl. No.: 15/033,745

(22) PCT Filed: Nov. 8, 2013
(86) PCT No.: PCT/EP2013/073420

§ 371 Date: May 2, 2016

(51) Int. Cl. B08B 1/00

(52) U.S. Cl. CPC B08B 1/006

(57) ABSTRACT

It comprises a sleeve (110) having an interior (120) for receiving at least one finger (130) of the user through at least one opening (140). The sleeve (110) comprises an inner portion(150), an applicator portion (160) at least part of which is suitable for applying a product, and a removable protective film (170) for at least partially covering the applicator portion (160). The removable protective film (170) may have at least one protective extension (180) to be pulled for removal. At least one end of the sleeve (110) may extend to at least one sleeve extension (190).

### TECHNICAL FIELD

The present disclosure relates to a finger wipe device that is suitable for applying a product such as for example a tooth cleaning product, a hygiene product or the like. The present finger wipe device finds application in many other fields where a product is to be applied.

### BACKGROUND ART

Finger wipes are known in the art as an alternative or in addition to typical dental cleaning devices such as toothbrushes, dental floss, interproximal brushes, etc. for improving oral hygiene. They usually comprise a sleeve which in use is adapted to partially wrap the user's finger. The sleeve may be provided with a given quantity of product or the product may be applied before cleaning the teeth. Then the user can brush her/his teeth easily wherever she/he is.

Finger wipes have been shown as an effective way of cleaning the teeth, gums, tongue, etc., since the use of the finger allows all parts of the mouth and of the teeth to be easily reached. This is advantageous since the user does not have to bring a toothbrush along with her/him, for example in restaurants, in the office, and in general outside the home.

For example, document WO02069753 discloses an oral cleaning device comprising a woven polypropylene sleeve. Inside the sleeve, a user's finger can be placed for the massaging of the gums, cleaning of the teeth and the administering of solutions and compounds of the teeth.

Document WO9531154 discloses a flexible rubber finger wipe. This finger wipe includes an active longitudinal strip of thick absorbent paper that is impregnated with a detergent product for the teeth. Said strip is further provided with a roughened surface. The finger wipe is provided inside a waterproof sealed packet.

Document WO0176523 discloses a finger wipe of the type mentioned above that is partially made from a texturized material having an abrasive surface for cleaning surfaces. Various additives can be applied to the finger wipe.

Document U.S. Pat. No. 5,320,531 refers to an absorbent finger wipe comprising an upper and lower portion which may be of differing lengths. The lower portion has an appendage attached thereto to facilitate safe removal of the finger wipe after use. The appendage prevents the user's finger from contacting the absorbent finger wipe when inserting her/his finger therein or when removing the finger wipe therefrom.

Such known finger wipes are in general easy to use as stated above. However they have the main disadvantage that protection of the wipe over time is not sufficiently ensured. This is particularly relevant depending on the nature of the product which in some cases could lose its properties over time, for example for tooth cleaning. In addition, known finger wipes also have the disadvantage that they do not properly protect the area of the wipe where the product to be applied so it is almost always contacted by the user's finger(s) before and during use of the finger wipe.

Therefore, a device is still required that provides improved cleaning of the teeth while ensuring protection both when the device is stored and when it is in use. In addition, a device is still required providing improved cleaning of the teeth while the properties of the product to be applied are maintained over time.

### SUMMARY

A wipe device suitable for applying a product has been devised which will be described hereinbelow in detail. With the present wipe device the above mentioned disadvantages are overcome. In addition, with such wipe device the above requirements are met and, in addition, a large number of additional advantages are obtained not only in tooth cleaning but also in many other applications.

The description will hereinafter refer to a wipe device suitable for being used by at least one finger. However, the present wipe device is also suitable for being used through any equivalent element such as a bar, a tool such as a mechanical tool, a surgical tool, etc.

The present finger wipe device comprises a sleeve. The sleeve defines an interior adapted for receiving at least one finger of the user such that the sleeve at least partially surrounds or wraps the user finger(s). In this regard, the sleeve of the present finger wipe device may be adapted not only for at least partially surrounding or wrapping one user's finger but for at least partially surrounding several fingers. Therefore, one embodiment of the present finger wipe device may include the one in which the device comprises a glove-shaped sleeve having an interior adapted for at least partially receiving the user's hand.

The sleeve has at least one opening through which the user's finger(s) can be inserted into the sleeve interior. Preferably, the opening is open before use. However, in some embodiments, the opening could remain closed before use through any known means, such as for example heat sealing or by any other suitable means.

The sleeve of the present finger wipe device comprises at least three portions, namely, an inner portion, an applicator portion and a removable protective portion. In some embodiments, at least one of such portions of the sleeve may be arranged defining a layer. Each portion or layer of the sleeve may be formed continuously or discontinuously. The portions or layers of the sleeve may have different characteristics from each other. The sleeve may be thus formed as a single body with different properties or it may be formed as a multi-layered body.

Specifically, the sleeve inner portion is adapted to be in contact with the user's finger(s) or to at least partially surround it/them. Said inner portion may be at least partially made of an impervious material (or impervious materials). As used herein, impervious material and similar terms means materials not allowing entrance or passage of fluids irrespective of their nature such that liquids and even gases are not allowed to enter the sleeve interior and therefore they can not contact the user's finger(s). There could be embodiments, for example, where the sleeve inner portion is completely made of an impervious material. Alternatively, there could be embodiments where the sleeve inner portion has an upper portion made of a non-impervious material and a lower portion made of an impervious material.

The sleeve applicator portion is formed in one or more portions of, or even throughout, the outside of the sleeve. At least part of the sleeve applicator portion is suitable for applying a product. This product might be already applied to the sleeve applicator portion but in some embodiments the sleeve applicator portion might not contain the product to be applied. The present finger wipe device may be thus of the dry or wet type.

A large variety of products can be applied through such sleeve applicator portion. Examples of products to be applied by the sleeve of the present finger wipe device are general oral hygiene products, chemical and antibacterial agents, mouthwash products, dental refreshing products, tooth bleaching products, intimate hygiene products, cosmetic products, self-care products, medical products, cleaning products such as for glasses, plastics, woods, metals, ceramics, products for cleaning machine parts, products for children, products for pets, plants, etc.

The removable protective portion of the sleeve is provided such that it is at least partially covering the sleeve applicator portion. Said protective portion is suitable for protecting the sleeve applicator portion from damages from impacts, scratches, etc. causing tears, ruptures, etc. and, at the same time, for protecting the product to be applied, when contained in the applicator portion, over time before use.

In some embodiments, the removable protective layer is a plastic thin film. Said removable protective film may be formed, for example, of a polymeric material. Materials such as polyethylene, polypropylene, polyester, nylon, polyvinyl chloride, are suitable. For the removable protective film textile materials, cellulose based materials, etc can also be used.

The removable protective film of the sleeve may provided with one or more protective extensions. The protective extensions are adapted to be pulled by the user for removing at least one part of the protective extension from the sleeve in order to use the finger wipe device. By pulling the protective extensions out, the removable protective film can be easily, rapidly and conveniently removed from the sleeve applicator portion and left the device ready for use.

The removable protective film may be wear resistant to protect the sleeve, and strong enough to protect the product in the applicator portion and, in turn, to protect the user when handling the device.

In some embodiments, the removable protective film may comprise several parts. For example, the protective film may comprise a first film portion that may at least partially cover a corresponding first portion of the sleeve applicator portion and a second film portion that may at least partially cover a corresponding second portion of the sleeve applicator portion. In this particular case, only one of the film portions could be removed from the sleeve applicator portion.

The sleeve of the present finger wipe device may have at least one sleeve extension. The sleeve extension is formed extending from at least one end of the sleeve, adjacent to the opening. The sleeve extension serves the purpose of protecting the user's finger, the user's hand or any part of the user's body when using the finger wipe device. Such sleeve extension is adapted to be inserted inside the sleeve, into the opening of the sleeve, when not in use. This can be carried out by folding the sleeve extension along its end where it is connected to the sleeve. In the event that the sleeve extension is part of the sleeve, both are formed by the above mentioned three portions. In any case, the removable protective film can be adapted for at least partially covering the sleeve extension.

It is preferred that at least one of the portions of the sleeve, and most preferable all three portions of the sleeve is made of a disposable material. This means that the wipe device could be discarded after a single use, for example. However, this may vary depending upon specific applications to which the wipe device is intended.

The finger wipe device may further include a package for storing at least one sleeve. The package may be in the form of pouches, sachets or the like, whose size substantially fits the size of the sleeve. The package may have a peelable strip that the user should pull off to access the inside and take the sleeve out of the package. Then, the user can insert her/his finger(s) through the sleeve opening and remove the protective film from the sleeve for use. If necessary, the sleeve extension should be taken out of the sleeve before inserting the user's finger(s). Finally, the user can apply the product that is inside the sleeve applicator portion. As stated above, the product may already be present in the sleeve applicator portion or it may be impregnated once the sleeve has been taken out of the sleeve and before it is used. In the first case, the package might contain therein the product to be applied. However, the product to be applied could be already impregnated in the sleeve applicator portion, covered by the sleeve applicator portion before use.

In some embodiments of the present finger wipe device, it is envisaged that the package is the removable protective portion described above.

The above described finger wipe device has been proven to be easy to use for any user. It has been also shown to be durable and, in the event that the product is already applied to the sleeve applicator portion, the product is preserved over time before use. The above described finger wipe device has been therefore proven to be highly advantageous whenever the product to be applied, if necessary, or where a typical toothbrush is not available to the user. Finally, the present protective film provides the important advantage that the user's finger(s) is/are prevented from contacting the sleeve applicator portion.

Additional objects, advantages and features of embodiments of the present finger wipe device will become apparent to those skilled in the art upon examination of the description, or may be learned by practice thereof.

### BRIEF DESCRIPTION OF THE DRAWINGS

Particular embodiments of the present finger wipe device will be described in the following by way of non-limiting examples, with reference to the appended drawings.

In the drawings:

FIG. 1 is a diagrammatic top plan view of one embodiment of finger wipe device;

FIG. 2 is a longitudinal cross-sectional view of one embodiment of the sleeve of the finger wipe device shown in FIG. 1; and

FIG. 3 is a longitudinal cross-sectional view of a further embodiment of the sleeve of the finger wipe device.

### DETAILED DESCRIPTION OF EMBODIMENTS

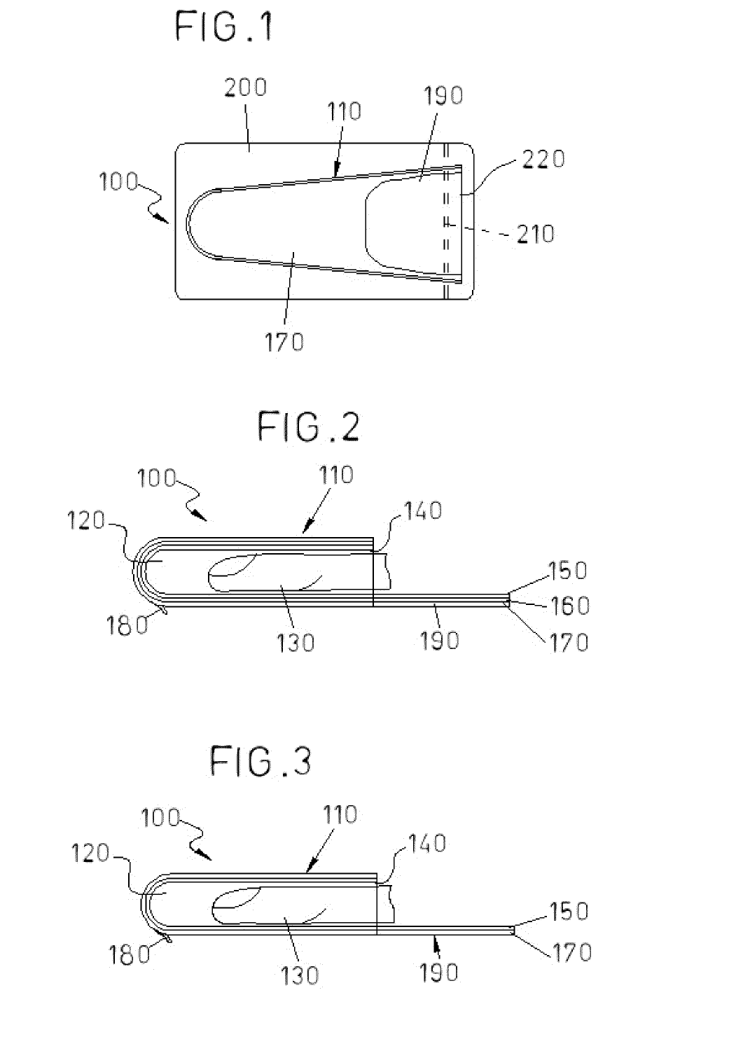

One non-limiting example of the present finger wipe device is shown in FIG. 1 and has been designated by reference numeral 100. This specific embodiment of the finger wipe device 100 shown is suitable for applying dental oral hygiene products. However, the finger wipe device 100 is not limited to this specific application and it can be used to apply a large variety of products such as intimate hygiene products, cosmetic products, self-care products, medical products, cleaning products such as for glasses, plastics, woods, metals, ceramics, products for cleaning machine parts, products for children, products for animals, pets, plants, etc.

The finger wipe device 100 comprises a sleeve 110 such as the one shown in FIG. 2 of the drawings. The sleeve 110 has an interior 120 that is suitably sized and shaped for receiving one user's finger 130. Other embodiments are not ruled out in which the interior 120 of the sleeve 110 is adapted to receive several user's fingers 130, such as for example all the fingers of the user's hand so that the finger wipe device 100 could be provided with a glove-shaped sleeve 110.

According to the embodiment of the sleeve 110 shown in FIG. 2, the interior 120 of the sleeve 110 can be accessed through an opening 140. The opening 140 is suitably sized so that the user's finger 130 can be inserted into the sleeve interior 120 as shown in FIG. 2.

As shown in FIG. 2, the sleeve 110 comprises three portions 150, 160, 170 which are described below. The three portions 150, 160, 170 of the sleeve 110 in this example are arranged in layers made of a disposable material so that the wipe device 100 can be discarded after a single use.

Specifically, the sleeve 110 comprises an inner layer 150 that is adapted to be in contact with the user's finger 130 or to at least partially surround it. The inner layer 150 is at least partially made of an impervious material so that liquids and gases are not allowed to enter the sleeve interior 120 and therefore liquids and gases can not contact the user's finger 130.

The sleeve 110 further comprises an applicator layer 160. In the specific embodiment shown in FIG. 2, the applicator layer 160 is provided throughout the sleeve inner layer 150 and it is impregnated with a product such as an oral hygiene product as stated above. In the specific application shown in the drawings the applicator layer 160 of the sleeve 110 is already impregnated with the product to be applied. Specifically in this case, the product is in a location of the applicator layer 160 corresponding to a lower portion of the sleeve 110.

The applicator layer 160 is a part of the sleeve 110 so although in some cases the applicator layer 160 might have a rough surface for brushing, there are no bristles formed therein. As a consequence, the use of the finger wipe device 100 does not result in irritation so users with sensitive oral tissues such as children can advantageously make use of the present wipe device 100.

According to an important feature of the present wipe device 100, the sleeve 110 further comprises a removable protective layer 170 that is provided covering the sleeve applicator layer 160, as shown in FIG. 2. The removable protective layer 170 is suitable for protecting the applicator layer 160 from being damaged or broken. Advantageously, said removable protective layer 170 is also suitable for protecting the product that is in the applicator layer 160 before use. When the wipe device 100 has not yet been used, the product to be applied is between the applicator layer 160 and the removable protective layer 170, covered and protected by the latter. A fresh product is therefore always available, retaining its properties and thus its effectiveness.

The removable protective layer 170 can be directly applied onto the applicator layer 160 or it may be adhered thereon through any suitable means.

In the embodiment shown in the drawings, the removable protective layer 170 is a plastic thin film which may be continuous or discontinuous. The removable protective film 170 may be made of a polymeric material. Materials such as polyethylene, polypropylene, polyester, nylon, polyvinyl chloride, are suitable. For the removable protective film 170 textile materials, cellulose based materials, etc can be also used. These materials may be also combined with a finish. For example, the removable protective film 170 may be made of a cellulose based material with a resin coating. Other materials such as metals and alloys (e.g. aluminium foils, metallized films, etc.), and processing (laminates, etc.) can be also used for making the removable protective film 170.

In applications where thickness should be greater, which will depend on the nature of the product to be applied, the removable protective film 170 may be a sheet of plastic material.

The removable protective film 170 is provided with one protective extension 180. The protective extension 180 extends out into a tab projecting from the lower portion of the protective film 170. Said protective extension 180 is adapted to be pulled by the user in order to remove the removable protective film 170 from the sleeve 110, that is, to remove the removable protective film 170 from the applicator layer 160, thus leaving the wipe device 100 ready for use, with the product exposed.

As shown in FIG. 2 of the drawings, the sleeve 110 extends from the end of the sleeve 110 that is adjacent to the opening 140 into a sleeve extension 190. The sleeve extension 190 is part of the sleeve 110 and therefore it also comprises the above mentioned three layers 150, 160, 170, that is, the inner layer 150, the applicator layer 160 and the removable protective film 170. Said sleeve extension 190 is adapted to extend substantially into the user's finger, for example, into the index finger 130 covering it including the proximal phalanx. Note that the sleeve 110, without considering said sleeve extension 190, covers the user's finger 130 up to the middle phalanx, that is, up to the knuckle of the index finger 130 in this example. This allows the user's finger 130 to be effectively protected when using the finger wipe device 100. In other embodiments, the sleeve extension 190 could extend to cover any part the user's body.

In the specific embodiment shown in FIG. 3, the sleeve 110 is formed of a single layer 150. The single layer 150 has an inner portion for receiving at least one finger 130 and an outer portion for applying the product. As with the embodiment shown in FIG. 2, the protective film 170 in the embodiment shown in FIG. 3 at least partially covers the applicator portion of the single layer 150.

Referring now to FIG. 1, the sleeve 110 is shown with the sleeve extension 190 folded and received into the sleeve 110. This arrangement can be used for storing the sleeve 110 into a package 200 which will be described further below. Specifically in this embodiment, the sleeve extension 190 can be folded along one end 220 where the sleeve extension 190 is connected to the sleeve 110 as shown in FIG. 1 and remaining in the interior 120 of the sleeve 110 before use.

As stated above, the sleeve 110 is stored inside a package 200 before use as shown in FIG. 1. The package 200 in this example is in the form of a sachet, suitable for storing one sleeve 110. In this embodiment, the size of the package 200 substantially fits the size of the sleeve 110. However, the package 200 could be suitable for storing several sleeves 110. The package 200 has a peelable strip 210 suitable for the user to easily pull it off to access the interior 120 of the sleeve 110 and taking a sleeve 110 out for use.

Once the sleeve 110 has been taken out of the package 200, the user can insert her/his finger(s) 130 (index finger as stated above) through the opening 140 of the sleeve and then remove the protective film 170 from the applicator layer 160 of the sleeve 110. This renders the oral hygiene product in the applicator layer 160 exposed and ready to be applied with the index finger 130 brushing the teeth and massaging the gums.

Although only a number of particular embodiments and examples of the present finger wipe device 100 have been disclosed herein, it will be understood by those skilled in the art that other alternative embodiments, uses and obvious modifications and equivalents thereof are possible. For example, any of the inner layer 150, the applicator layer 160 and the removable protective film 170 may be a continuous layer, but alternatively any of such layers 150, 160, 170 could be made of discrete portions.

The present disclosure thus covers all possible combinations of the particular embodiments described and its scope should not be limited by the particular embodiments described herein, but should be determined only by a fair reading of the claims that follow.

Reference signs related to drawings and placed in parentheses in a claim, are solely for attempting to increase the intelligibility of the claim, and shall not be construed as limiting the scope of the claim.

1. Finger wipe device (100) for applying a product, the device (100) including a sleeve (110) comprising an inner portion (150) adapted for receiving at least one finger (130) through at least one opening (140) of said sleeve (110), the sleeve (110) further comprising an applicator portion (160) at least part of which is suitable for applying a product, wherein the sleeve (110) further comprises a removable protective portion (170) for at least partially covering the applicator portion (160).

2. Finger wipe device (100) as claimed in claim 1, wherein the removable protective portion (170) comprises at least one protective extension (180) adapted to be pulled for removing at least one part of the removable protective portion (170) from the sleeve (110).

3. Finger wipe device (100) as claimed in claim 1 or claim 2, wherein the removable protective portion (170) comprises at least a first film portion for at least partially covering a corresponding first portion of the sleeve applicator portion and a second film portion for at least partially covering a corresponding second portion of the sleeve applicator portion.

4. Finger wipe device (100) as claimed in any of the preceding claims, wherein the applicator portion (160) includes a product to be applied.

5. Finger wipe device (100) as claimed in any of the preceding claims, wherein the inner portion (150) of the sleeve (110) is at least partially made of an impervious material.

6. Finger wipe device (100) as claimed in any of the preceding claims, wherein at least one end of the sleeve (110), adjacent to said opening (140), extends to at least one sleeve extension (190).

7. Finger wipe device (100) as claimed in claim 6, wherein the sleeve extension (190) is adapted to be inserted inside the sleeve (110) into the opening (140) when not in use.

8. Finger wipe device (100) as claimed in claim 6 or 7, wherein the protective portion (170) is also adapted for at least partially covering the sleeve extension (190) of the sleeve (110).

9. Finger wipe device (100) as claimed in any of the preceding claims, wherein at least one of the portions (150, 160, 170) of the sleeve (110) is made of a disposable material.

10. Finger wipe device (100) as claimed in any of the preceding claims, wherein at least one of the portions (150, 160, 170) of the sleeve (110) is arranged defining a layer.

11. Finger wipe device (100) as claimed in any of the preceding claims, wherein it further includes a package (200) for storing at least one sleeve (110).

12. Finger wipe device (100) as claimed in claim 11, wherein the size of the package (200) substantially fits the size of the sleeve (110).

13. Finger wipe device (100) as claimed in claim 11 or 12, wherein the package (200) is the removable protective portion (170).

14. Finger wipe device (100) as claimed in any of the claims 11 to 13, wherein the package (200) contains therein a product to be applied through the applicator portion (160).

15. Finger wipe device (100) as claimed in any of the preceding claims, wherein the removable protective portion (170) is made of at least one material selected from the group consisting of polyethylene, polypropylene, polyester, nylon, polyvinyl chloride, textile materials, cellulose based materials and metals.
